(19) United States
(12) Patent Application Publication
(10) Pub. No.: US 2005/0116510 A1
(43) Pub. Date: Jun. 2, 2005

(54) Motor vehicle roof with a center console extending in the lengthwise direction of the roof

(75) Inventors: Alain Leroy, Diessen-Dettenschwang (DE); Miriam Schonauer, Nandlstadt (DE); Thomas Rudolph, Hechendorf (DE)

Correspondence Address: NIXON PEABODY, LLP, 401 9TH STREET, NW, SUITE 900, WASHINGTON, DC, 20004-2128, US

(73) Assignee: WEBASTO AG, Stockdorf (DE)

(21) Appl. No.: 10/936,718

(22) Filed: Sep. 9, 2004

(30) Foreign Application Priority Data
Sep. 9, 2003 (DE) 103 41 558.0

(51) Int. Cl. B60J 7/043

(52) U.S. Cl. 296/216.01

(57) ABSTRACT

A motor vehicle roof is provided which includes a center console mounted fixed on the roof body and extending in the lengthwise direction of the roof. The top of the console forms the outer surface of the roof. At least one transparent area extends laterally from the center console to a body-mounted limit. The top of the transparent area forms the outer surface of the roof in this area. The center console has at least one cubby hole.

### BACKGROUND OF THE INVENTION

1. Field of the Invention

The present invention relates to a motor vehicle roof with a center console which extends in the lengthwise direction of the roof.

2. Description of Related Art

A conventional motor vehicle roof with a center console which extends in the lengthwise direction of the roof is shown in published German Patent Application 101 58 742 A1. In that design, the top of the center console forms a portion of the outer surface of the roof and two adjustable glass covers are provided on either side of the center console between the center console and the roof frame to form the outer surface of the roof in this area. On the bottom of the center console, there is a flat display which can be folded out, controls for adjusting the glass covers or for the flat display and means which provide data to the flat display.

In an older German patent application 103 15 635, which had not been published beforehand, a motor vehicle roof is described in which a center console, extending in the lengthwise direction of the roof, is mounted underneath the roof surface which is formed by the transparent cover. Plate-like sunscreening elements may be provided which can be moved in the lengthwise direction of the roof and which are located either completely above the center console or only laterally from the center console. The center console can contain different useful means for the passenger, for example a cubby hole, a display, lighting or ventilation.

In an older German patent application 103 31 271, which had not been published beforehand, a motor vehicle roof is described with a center console which is located underneath a transparent roof area and which can be pulled out in the lengthwise direction of the roof. On either side of the center console, there can be sunscreening elements which can be moved in the lengthwise direction of the roof.

Published German patent application 43 40 980 A1 discloses a center console for a motor vehicle roof which can be mounted in the opening of a sliding roof.

Great Britain patent application 2 134 464 A discloses a head liner module for a motor vehicle roof, a center console which is provided on its bottom with different function elements being integrated into the head liner module.

Published German patent application 100 56 041 A1 discloses a roof cap for a motor vehicle which has luggage compartments which are laterally accessible from the outside.

Published German patent application 37 17 826 A1 discloses a roof cap for a bus which is made as a luggage space which is accessible from underneath through a hatch in the roof.

German patent 196 43 188 C1 discloses a motor vehicle roof with two rigid air vents which are located in the rear roof area.

### SUMMARY OF THE INVENTION

One object of the present invention is to provide a motor vehicle roof having easily accessible additional stowage space.

A second object of the present invention is to provide a motor vehicle roof with a center console and lateral transparent areas which includes optimum shadowing of the transparent areas with reference to the vehicle interior in a simple and space-saving manner.

A third object of the present invention is to provide a motor vehicle roof with a center console which enables a flexible ventilation function.

The above objects, and other objects, are achieved by providing a motor vehicle roof with a center console having at least one pigeonhole thereby creating additional stowage space in an aesthetically pleasing manner. The stowage space can be easily accessible to the vehicle passengers. Also, it is especially advantageous that an additional stowage space can be created which is especially easily accessible to the vehicle passengers and aesthetically pleasing in combination with movability of the glove box to provide great flexibility with respect to use by the vehicle passengers. In addition, by enhanced flexibility in the use of the center console, especially as a stowage space, an especially large shelf space can be formed, while, during use of the vehicle without a major demand for stowage space, still a relatively low structural height of the motor vehicle roof is ensured.

The present invention is also advantageous in that an especially space-saving support of the cover elements can be provided because the cover elements are held in the center console in the position which clears the transparent area.

The present invention is also advantageous in providing a flexible ventilation function in an aesthetically pleasing manner. In particular, an adverse aesthetic effect on the appearance of the roof surface can be avoided in the time intervals in which a ventilation function is not desired since then it is not necessary to raise the ventilation flaps.

### BRIEF DESCRIPTION OF THE DRAWINGS

FIG. 1 shows a schematic perspective of a first embodiment of a motor vehicle roof of the present invention from overhead;

FIG. 2 shows a view similar to FIG. 1 but of a modified embodiment of the present invention;

FIG. 3 shows a cross sectional view of the motor vehicle roof from FIG. 1;

FIG. 4 shows a schematic perspective of another embodiment of the motor vehicle roof of the present invention from the vehicle interior;

FIGS. 5 and 6 show schematic perspectives of two embodiments of the outer roof surface of the motor vehicle roof from FIG. 4;

FIG. 7 shows a view similar to FIG. 4 but of a modified embodiment of the present invention;

FIG. 8 shows a schematic cross sectional view of the motor vehicle roof from FIG. 7;

FIG. 9 shows a schematic perspective of the outer roof surface of the motor vehicle roof from FIG. 7;

FIGS. 10-12 show views similar to FIGS. 7-9 but of a modified embodiment of the present invention;

FIG. 13 shows a schematic perspective of another embodiment of the motor vehicle roof of the present invention from the vehicle interior;

FIG. 14 shows a schematic perspective of another embodiment of the motor vehicle roof of the present invention from the vehicle interior;

FIG. 15 shows a schematic cross section of the motor vehicle roof from FIG. 14 with cover elements located in the rest position;

FIG. 16 shows a schematic perspective of the outer roof surface of another embodiment of a motor vehicle roof of the present invention with the center console pulled out to the top;

FIG. 17 shows a view like FIG. 16 but with the center console shown in the rest position;

FIGS. 18-20 show schematic perspective views of other embodiments of the motor vehicle roof of the present invention from the vehicle interior; and

FIG. 21 shows a schematic perspective of the outer roof surface of another embodiment of a motor vehicle roof of the present invention with the ventilation flaps raised.

### DETAILED DESCRIPTION OF THE INVENTION

FIGS. 1 and 3 show a first embodiment of a motor vehicle roof of the present invention with a center console 10 which is mounted fixed on the body and which extends in the lengthwise direction of the roof; the top of the console in this area forming the outer surface of the roof. To either side of the center console 10, there is one transparent area 14 which extends from the center console 10 to the body-mounted limit 12, the top of this transparent area forming the outer surface of the roof in this area. The front end of the center console is followed by another transparent area 16 which extends over the entire width of the roof and its top forms the outer roof surface in this area. The top of the center console 10 is provided in its central area with eyes 18 which can be used to fix belts and/or other devices for roof loads (not shown in FIG. 3).

As shown in FIG. 3, the center console is made as a cubby hole which is accessible from the vehicle interior and which extends over the entire width of the center console 10. The cubby hole is open on the left side as shown in FIG. 3, the cross section of the cubby hole being essentially C-shaped.

The top of the center console 10 is higher than the lateral limits 12 and the transparent areas 14 so that the top of the center console 10 projects up above the transparent areas 14. The transparent areas 14 are arched slightly upward in the transverse direction of the roof. The top of the center console 10 is also arched slightly upward.

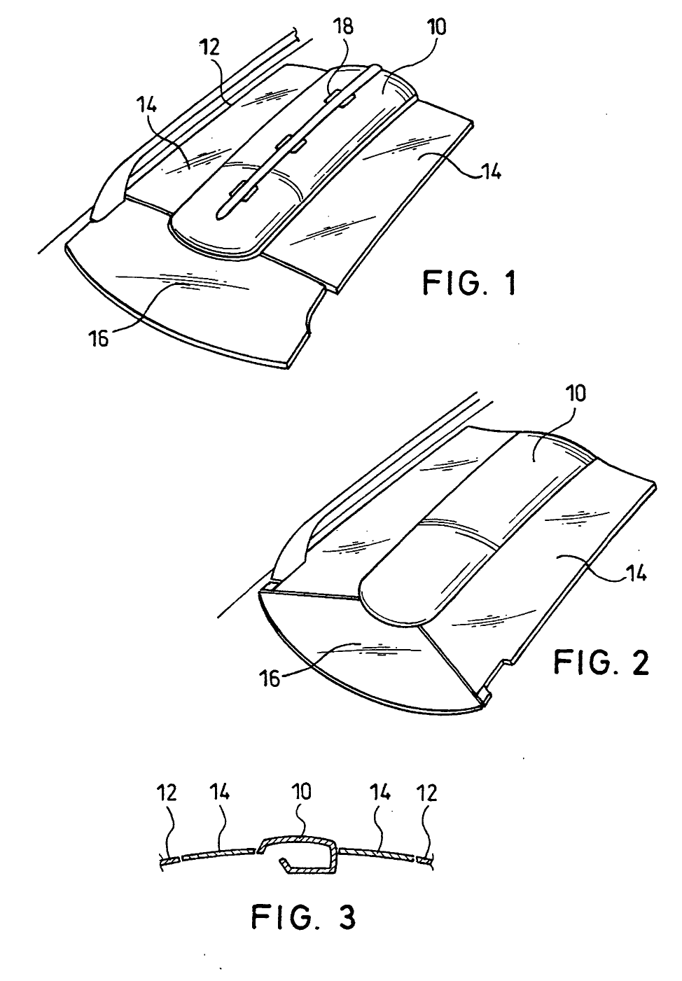

FIG. 2 shows a modified embodiment with the top of the center console 10 being essentially flush with the edge of the respective transparent area 14 which borders the center console 10 at the time. Overall the top of the center console 10 and the transparent areas 14 are arched up in the manner of a dome with respect to the lateral limits 12.

In general, the transparent areas 14 can be formed by glass or plastic panes.

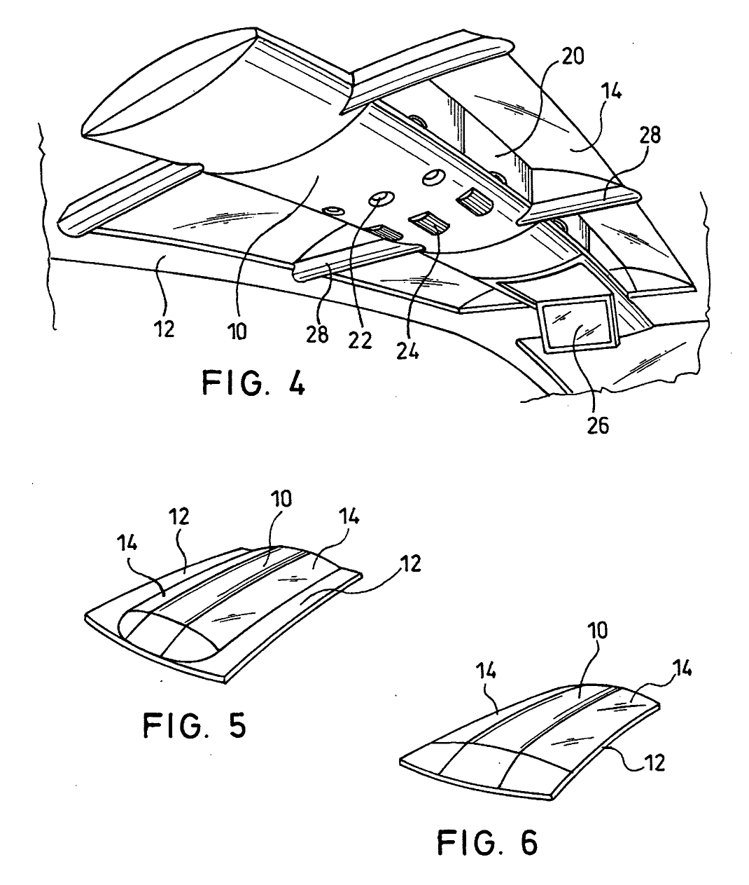

FIG. 4 shows a schematic of the bottom of a motor vehicle roof in the manner of FIGS. 1 and 2. The bottom of the center console 10 projects downwardly with respect to the edge of the transparent areas 14 which borders the center console 10. In the area of the center console 10 which projects downwardly, there are several flaps 20 positioned laterally which can be opened from the vehicle interior in order to make accessible the cubby holes which are formed in the center console 10. As shown in FIG. 4, on the bottom of the center console 10, different function elements such as for example lighting elements 22, ventilation openings 24 and a flat display 26 which can be folded down, are provided. Additional function elements can be provided, for example, controls, acoustic converters, especially speakers, display elements, power supply connections, folding mirrors, attachment eyes, or luggage nets.

On the two sides of the center console 10, there is one cross brace 28 at a time which is located underneath the corresponding transparent area 14 and which extends in the transverse direction from the center console 10 to the respective lateral limit 12. The cross braces 28 can act as a support for the respective transparent area 14.

FIGS. 5 and 6 show two examples for the configuration of the surface of the motor vehicle roof from FIG. 4. In both cases, the top of the center console 10 is flush with the edge of the respective transparent area 14 which adjoins the center console 10, and the top of the center console 10 and the lateral transparent areas 14 are arched upward in the manner of a dome with respect to the lateral limit 12.

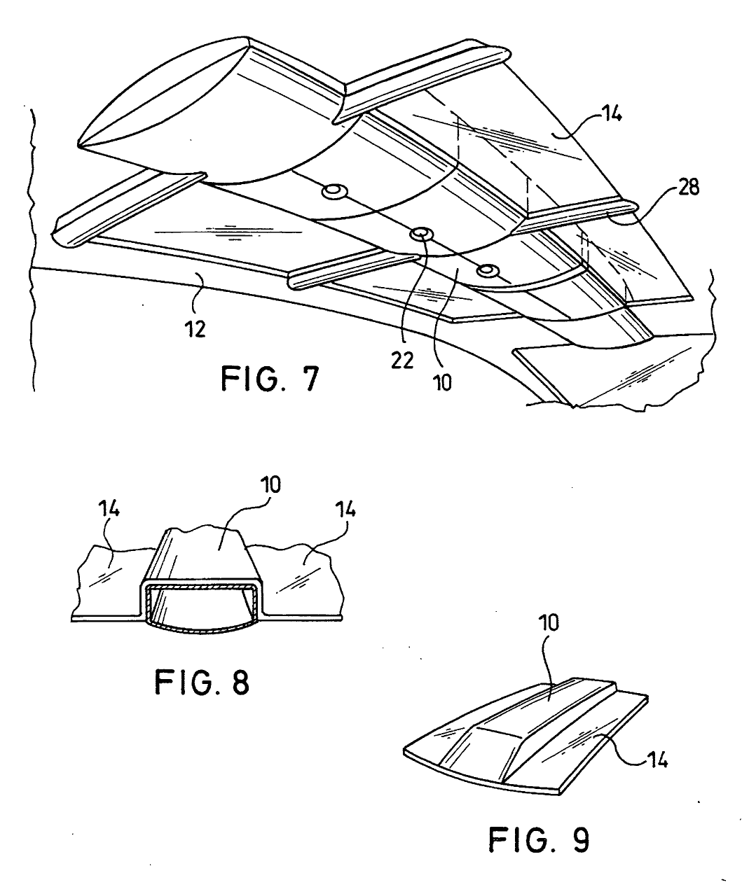

FIGS. 7 to 9 show a modified embodiment of a motor vehicle roof with a center console 10. In contrast to the embodiment from FIG. 4, the bottom of the center console is essentially flush with the edge of the respective transparent area 14 which adjoins the center console 10. The transparent areas 14 rest directly on the cross braces 28.

Another difference of the embodiment of FIGS. 7 to 9 relative to the embodiment of FIGS. 4 to 6 is that the center console 10 is made such that its top projects up with respect to the transparent areas 14 which are made essentially even.

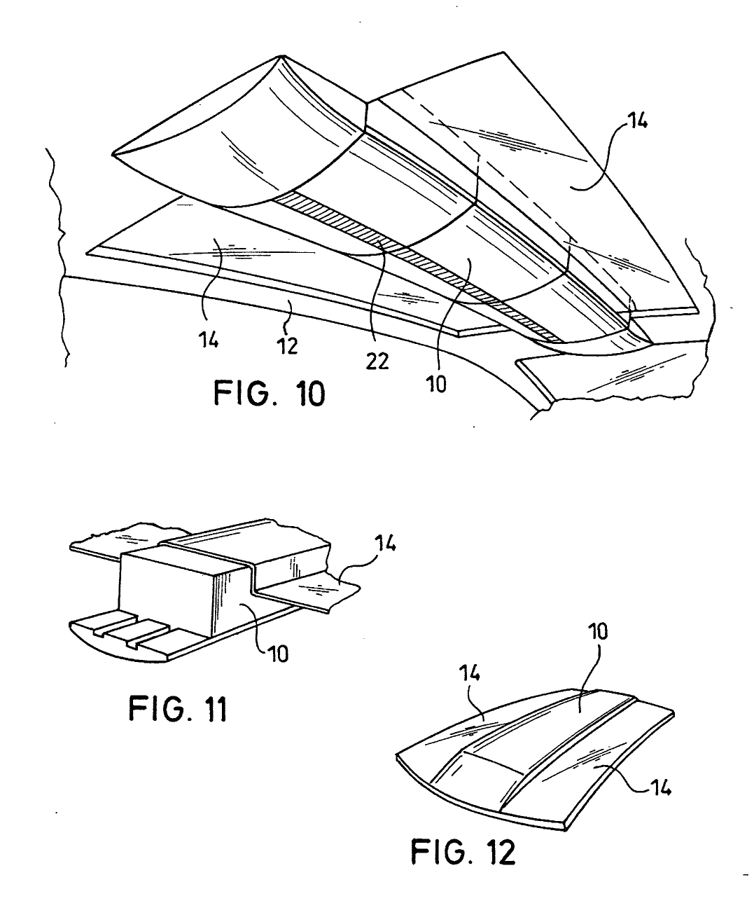

FIGS. 10 to 12 show an embodiment which has been modified with respect to the embodiment of FIGS. 7 to 9, in which the center console 10 is made such that both the top of the center console 10 projects up with respect to the edge of the transparent areas 14 which borders the center console 10 as well as the bottom of the center console 10 projects down with respect to the edge of the transparent areas 14 which borders the center console 10. Furthermore, on the bottom of the center console 10 there is a strip-shaped lighting means 22 which extends in the lengthwise direction.

Of course, the roof console 10 also has at least one cubby hole (not shown in the Figures) in the embodiments of FIGS. 7 to 12.

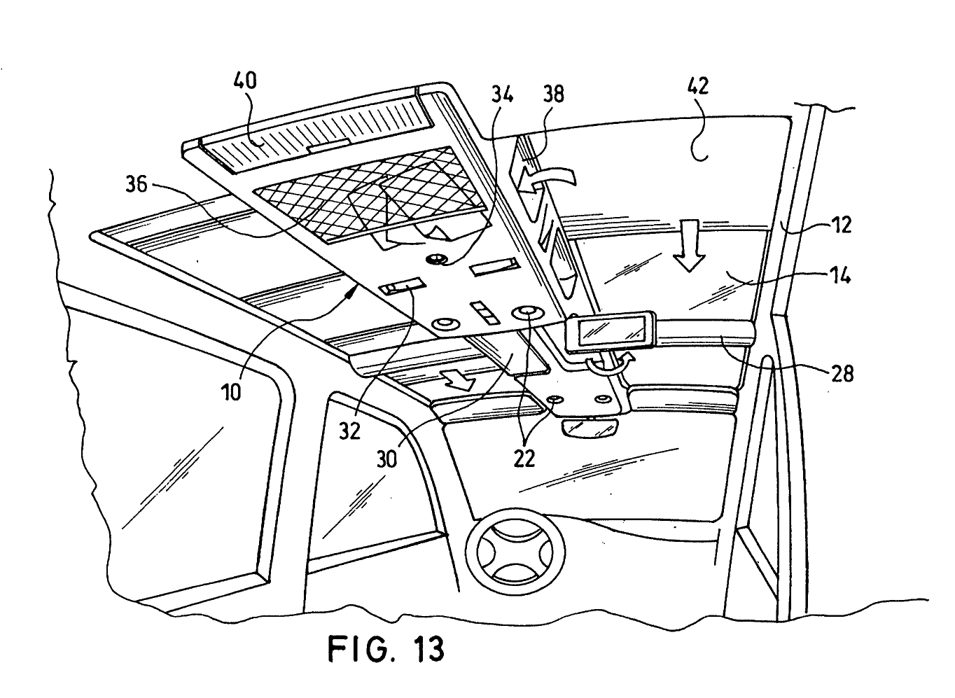

FIG. 13 shows another embodiment of a motor vehicle roof with a center console 10 in which different function elements are provided on the bottom of the center console 10, and, specifically, lighting elements 2, mirrors which can fold out sideways, attachment eyes 32 for transport of articles of clothing or the like, a 12-volt power supply connection 34 and a luggage net 36. Laterally on the lower part of the center console 10, there are several openings 38 for the cubby holes which are formed in the center console 10. Furthermore, a flat lighting element 40 is provided on the back end of the bottom of the center console 10.

Underneath the transparent areas 14 on the two sides of the center console 10 there are cover elements 42 which can be moved in the lengthwise direction of the roof in order to prevent overly strong light incidence through the transparent areas 14 into the vehicle interior (in FIG. 13 the left transparent area 14 is hidden by these cover elements 42 with respect to the vehicle interior). The cover elements 42 can be made in the conventional manner as retractable shades or as plates which can be moved in the lengthwise direction of the roof wherein the lateral limit 12 and the corresponding side of the center console 10 are used as the guide for the respective cover element 42.

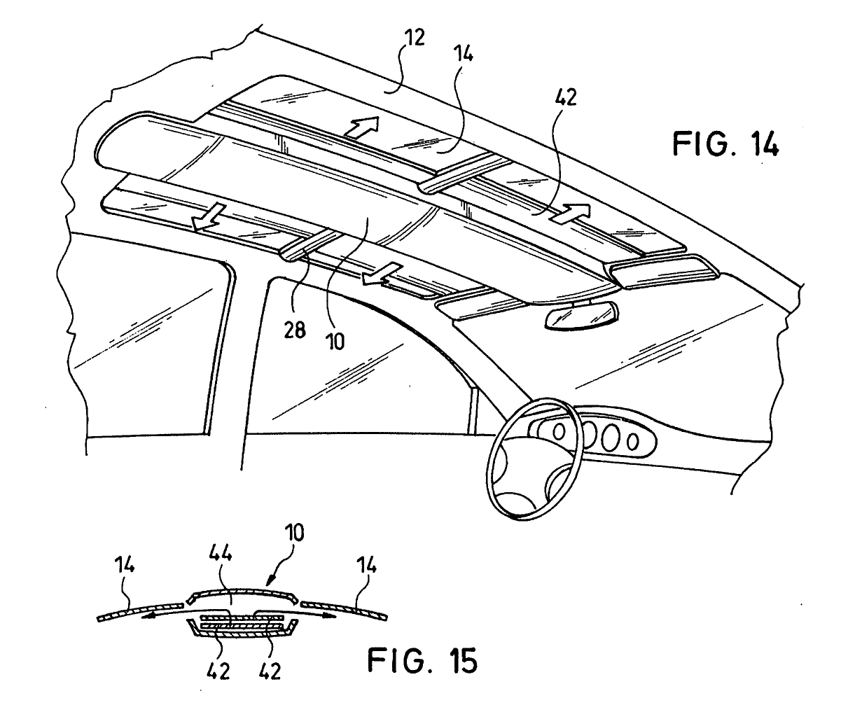

FIGS. 14 and 15 show a modified embodiment of the center console with cover elements in which the cover elements 42 can be moved in the transverse roof direction instead of in the lengthwise roof direction. The cover elements are made plate-shaped and are located in pairs opposite one another in the transverse direction of the roof. There are two pairs of these cover elements 42 which are separated by a cross brace 28. The cover elements 42 are movably supported on their front and their back ends in the transverse direction of the roof, the cross braces 28 being included as a guide.

The dimensions of the center console 10 and the cover elements 42 are chosen such that in the position in which two cover elements (arranged in pairs opposite one another) are positioned to clear the respective transparent area 14 for unobstructed light incidence into the vehicle interior, these two cover elements 42, as shown in FIG. 15, lie on top of one another and are deposited completely in a cavity or storage space 44 which is made in the center console 12.

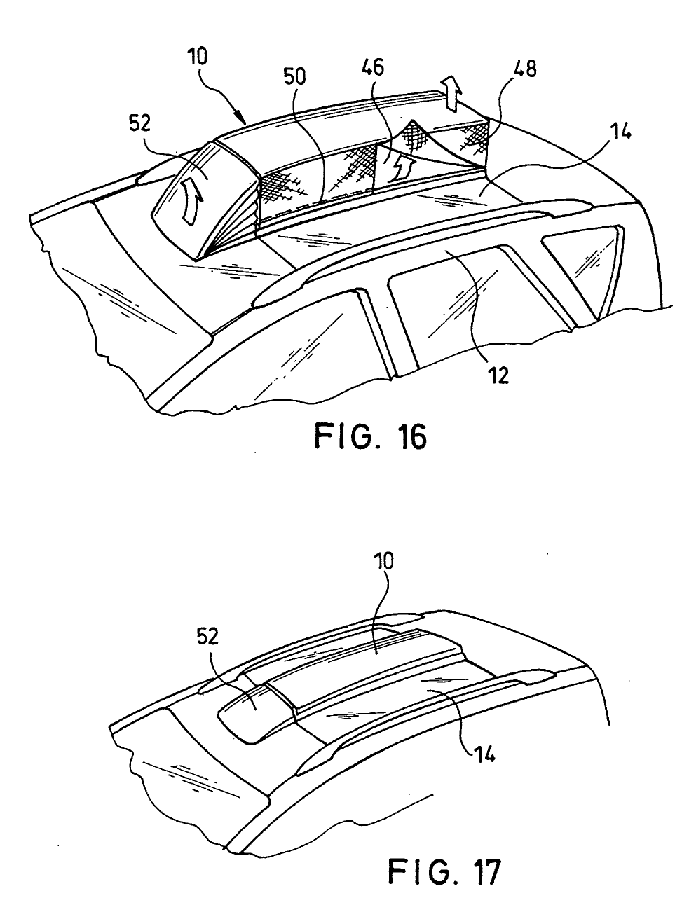

FIGS. 16 and 17 show another embodiment of a motor vehicle roof with a center console 10. The center console being movable in the vertical direction of the roof between a rest position which is shown in FIG. 17 and an operating position which is shown in FIG. 16. The top of the center console 10 in the operating position is higher than in the rest position. As shown in FIG. 16, the center console 10 in the operating position forms a shelf space 46 which is accessible laterally above the fixed roof surface. The fixed roof surface is preferably formed between the center console 10 and the lateral limit 12 to either side of the center console 10 as a transparent area 14.

In the operating position as shown in FIG. 16, a gap forms laterally between the fixed roof surface 14 and the top of the center console 10 and it is used as access to the shelf space 46. The gap can be closed by a tarpaulin 48. The tarpaulin 48 can be closed by means of zippers 50 and is made as a reinforced fabric.

The front end 52 of the top of the center console 10 is made as a section which acts as a wind deflector in the operating position and which can be raised for the operating position with its back end.

As shown in FIG. 17, the top of the center console 10 in the rest position is integrated into the fixed roof surface 14, this also applying to the front end 52.

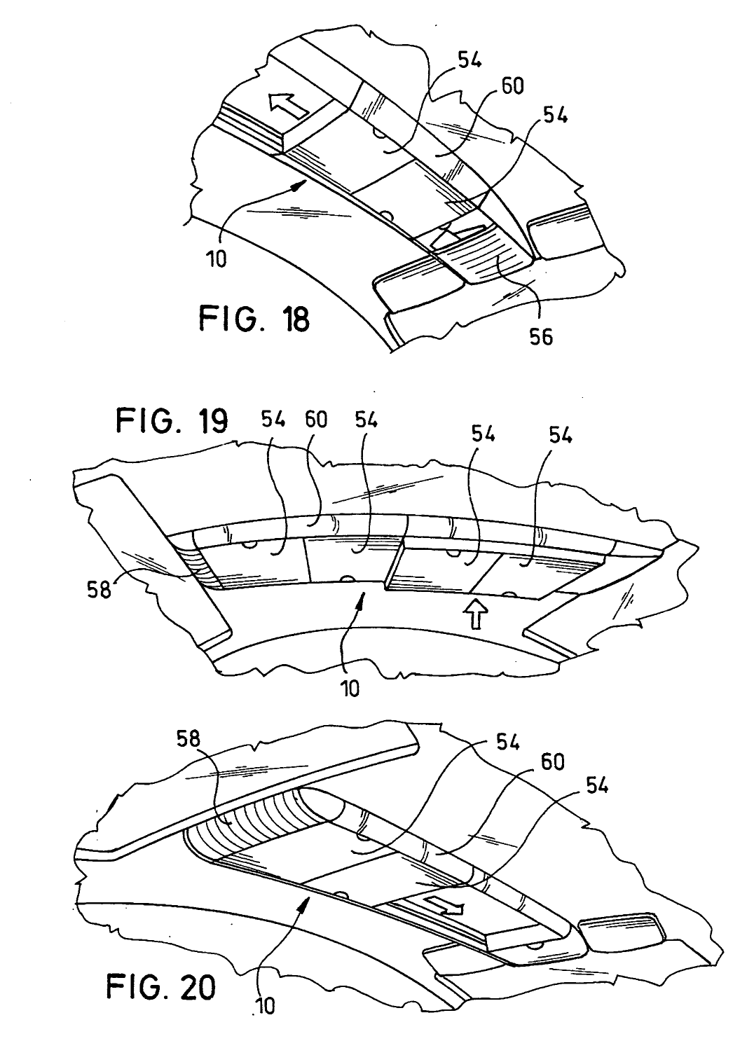

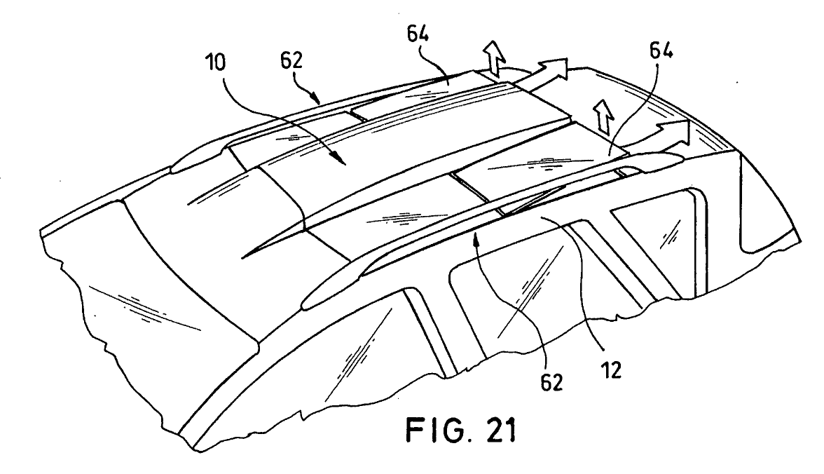

FIGS. 18 to 20 schematically show another embodiment of the motor vehicle roof with a center console 10 wherein, on the bottom of the center console 10, there are two glove boxes accessible from the vehicle interior and moveable in the lengthwise direction of the roof along the center console 10. As shown in FIG. 19, two additional glove boxes 54 can be inserted from underneath, i.e. by movement in the vertical direction of the roof in the center console 10 if necessary. By opposite motion the glove boxes can be removed again from the center console 10.

On the bottom of the front end section of the center console 10, there is a luggage pocket 56 (see FIG. 18).

On the back end of the bottom of the center console 10, there is an additional brake light 58, while the center console is provided laterally with lighting elements 60 which run in the lengthwise direction of the roof.

FIG. 21 shows another embodiment of a motor vehicle roof with a center console 10, wherein on either side of the center console 10, between the center console 10 and the lateral limit 12, a lateral area 62 is provided which is preferably made transparent. The rear section of the two lateral areas 62 is made as a ventilation flap 64 which can be raised on its back end. When the ventilation flaps 64 are raised, a ventilation gap forms between their back edge and the fixed roof surface.

The top of the center console 10 is made in one piece with the front fixed section of the lateral area 62 and the top of the center console being arched up with respect to the side area 62.

Preferably, the top of the center console and the lateral area 62, including the ventilation flaps 64, are made of polycarbonate.

In the other embodiments, especially in the embodiments shown in FIGS. 2, 5, 6, 8, 9, 11, and 12, the top of the center console 10 can be made in one piece with the lateral transparent areas 14, preferably polycarbonate being chosen as the material.

1. A motor vehicle roof, comprising:
a center console extending in a lengthwise direction of the roof, said center console including a top forming an outer surface of the roof, said center console including at least one cubby hole; and
at least one transparent area extending laterally from the center and including a top forming an outer surface of the roof.

2. The motor vehicle roof of claim 1, wherein said at least one cubby hole is accessible from the vehicle interior.

3. The motor vehicle roof of claim 2, wherein said at least one cubby hole is open on one of two sides, said at least one cubby hole having a C-shaped cross section.

4. The motor vehicle roof of claim 1, wherein said at least one cubby hole extends over an entire width of the center console.

5. The motor vehicle roof of claim 1, wherein a front end of the center console is followed by another transparent area extending over an entire width of the roof, said another transparent area includes a top forming an outer roof surface.

6. The motor vehicle roof of claim 1, wherein the top of the center console is higher than lateral limits of the roof.

7. The motor vehicle roof of claim 6, wherein the top of the center console and the at least one lateral transparent area are arched up in a manner of a dome with respect to the lateral limits of the roof.

8. The motor vehicle roof of claim 6, wherein the at least one lateral transparent area is curved.

9. The motor vehicle roof of claim 1, wherein the top of the center console is flush with an edge of the at least one lateral transparent area which borders the center console.

10. The motor vehicle roof of claim 1, wherein the top of the center console projects up over the at least one lateral transparent area.

11. The motor vehicle roof of claim 1, wherein a bottom of the center console is at least approximately flush with an edge of the at least one transparent area which adjoins the center console.

12. The motor vehicle roof of claim 1, wherein the at least one lateral transparent area includes two lateral transparent areas formed by glass or plastic panes.

13. The motor vehicle roof of claim 1, wherein both a bottom as well as a top of the center console project down and up, respectively, with respect to the at least one lateral transparent area.

14. The motor vehicle roof of claim 1, wherein further including at least one cross brace on each of two sides of the center console, said at least one cross brace located underneath the corresponding transparent area and extending in the transverse direction from the center console.

15. The motor vehicle roof of claim 14, wherein the cross braces act as a support for the respective lateral transparent area.

16. The motor vehicle roof of claim 1, further including cover elements which can be adjusted in one of the lengthwise direction and a transverse direction of the roof, said cover elements moveable into a position underneath the lateral transparent areas in order to cover the lateral transparent areas with respect to the vehicle interior.

17. The motor vehicle roof, comprising:
a center console extending in a lengthwise direction of the roof;
a transparent lateral area extending laterally from the center console to a lateral roof limit;
at least one cover element on each side of the center console underneath the transparent lateral area, the cover elements being adjustable to clear the transparent lateral area in one position and cover the transparent lateral area in another position with respect to the vehicle interior, the cover elements each being adjustable in a transverse direction of the roof and being held in the center console in the position which clears the transparent lateral area.

18. The motor vehicle roof of claim 17, wherein the cover elements are made as plates held in the position which clears the transparent lateral area in a storage space which is formed in the center console.

19. The motor vehicle roof of claim 18, wherein the cover elements can be pushed on top of one another in the storage space.

20. The motor vehicle roof of claim 17, wherein the cover elements are located in pairs opposite one another in the transverse direction of the roof.

21. The motor vehicle roof of claim 17, wherein the cover elements are separated from one another in the lengthwise direction of the roof by roof-mounted cross braces.

22. The motor vehicle roof of claim 17, wherein the cover elements are movably supported on their front and on their back end in a roof-mounted guide in the transverse direction of the roof.

23. A motor vehicle roof, comprising:
a center console extending in a lengthwise direction of the roof and including a bottom;
at least one glove box positioned on the bottom of the center console, said at least one glove box being accessible from the vehicle interior and moveable in the lengthwise direction of the roof along the center console.

24. The motor vehicle roof of claim 23, wherein said at least one glove box is insertable into, and removable from, the center console by movement in a vertical direction of the roof.

25. The motor vehicle roof of claim 23, further including a luggage pocket on the bottom of a front end section of the center console.

26. The motor vehicle roof of claim 23, further including an additional brake light on a back end of the bottom of the center console.

27. The motor vehicle roof of claim 23, wherein the center console is provided laterally with lighting elements which run in the lengthwise direction of the roof.

28. A motor vehicle roof, comprising:
a fixed roof surface;
a lateral roof limit;
a center console extending in a lengthwise direction of the roof and located in said fixed roof surface;
wherein said fixed roof surface extends laterally from the center console to a lateral roof limit, a top of the center console and a top of the fixed roof surface forming an outer surface of the roof, the center console being movable in the vertical direction of the roof between a rest position and an operating position, the top of the center console in the operating position being higher than in the rest position.

29. The motor vehicle roof of claim 28, wherein the center console forms a shelf space in the operating position.

30. The motor vehicle roof of claim 29, wherein the shelf space is accessible laterally above the fixed roof surface when the center console is in the operating position.

31. The motor vehicle roof of claim 30, wherein, in the operating position, a gap forms laterally between the fixed roof surface and the top of the center console, said gap being used as access to the shelf space and closeable by a tarpaulin.

32. The motor vehicle roof of claim 31, further including zippers for closing the tarpaulin.

33. The motor vehicle roof of claim 31, wherein the tarpaulin is made as a reinforced fabric.

34. The motor vehicle roof of claim 28, wherein a front end of the top of the center console forms a section which acts as a wind deflector in the operating position and which can be raised at a back end for the operating position.

35. The motor vehicle roof of claim 28, wherein the top of the center console in the rest position is integrated into the fixed roof surface.

36. A motor vehicle roof, comprising:
a center console extending in a lengthwise direction of the roof;
a lateral area extending laterally from the center console to a lateral roof limit, a top of the center console and a top of the lateral area forming an outer surface of the roof;
one flap positioned in the lateral area on each side of the center console, said flap having a rear edge which is raiseable to form a ventilation gap.

37. The motor vehicle roof of claim 36, wherein said flaps forming ventilation gaps are positioned at a back end of the lateral area.

38. The motor vehicle roof of claim 36, wherein the top of the center console is integral with the lateral area.

39. The motor vehicle roof of claim 36, wherein the top of the center console is arched up.

40. The motor vehicle roof of claim 36, wherein the top of the center console and the lateral area, including the ventilation flaps, are made of polycarbonate.

41. The motor vehicle roof of claim 36s, wherein the top of the center console is provided with attachment eyes.

42. The motor vehicle roof of claim 36, further including function elements on the bottom of the center console.

43. The motor vehicle roof of claim 42, wherein the function elements are at least one of ventilation elements, lighting elements, controls, acoustic converters, display elements, power supply connections, folding mirrors, attachment eyes and/or luggage networks.

44. The motor vehicle roof of claims 1, wherein the top of the center console is formed in one piece with the at least one transparent area.
